(19) United States
(12) Patent Application Publication
(10) Pub. No.: US 2026/0321180 A1
(43) Pub. Date: Oct. 15, 2026

(54) LAYERED DISPLAY FOR ELECTRONIC DEVICES

(71) Applicant: Hewlett-Packard Development Company, L.P., Spring, TX (US)

(72) Inventors: Alexander Williams, Spring, TX (US); Gregory Staten, Spring, TX (US); Syed S. Azam, Tomball, TX (US)

(73) Assignee: Hewlett-Packard Development Company, L.P., Spring, TX (US)

(21) Appl. No.: 19/484,312

(22) PCT Filed: May 19, 2023
(86) PCT No.: PCT/US2023/022942

§ 371 Date: Nov. 13, 2025

(51) Int. Cl. G09G 3/20; G02F 1/167; G09G 3/3216; G09G 3/3225

(52) U.S. Cl. CPC G09G 3/2092; G02F 1/167; G09G 3/3216; G09G 3/3225; G09G 2320/103; G09G 2330/021; G09G 2340/0435

(57) ABSTRACT

An electronic device can include memory, a display, and a processor. The display can include both a transparent emissive layer having a first display region and an electrophoretic layer having a second display region. The first display region and the second display region can have matching resolutions, and the transparent emissive layer and the electrophoretic layer can be individually addressable. The processor can execute machine-readable instructions stored in the memory to receive content for presentation via the display, separate the content into active content and passive content, present the active content via the transparent emissive layer, and present the passive content via the electrophoretic layer.

### BACKGROUND

Electronic devices, including various types of portable electronic devices, can include an electronic display and can perform a variety of functions. Using the electronic display, the electronic devices can display video content, such as streaming video or still images. The electronic devices consume power when causing the electronic display to display video content.

### BRIEF DESCRIPTION OF THE DRAWINGS

FIG. 1 is a block diagram showing example components of an example electronic device, in accordance with some aspects of the disclosure.

FIG. 2 is a block diagram showing example components of a display of the electronic device of FIG. 1, in accordance with some aspects of the disclosure.

FIG. 3 is a perspective illustration of a transparent emissive layer and an electrophoretic layer of the display of FIG. 2, in accordance with some aspects of the disclosure.

FIG. 4 is a block diagram showing example components of another example electronic device, in accordance with some aspects of the disclosure.

FIG. 5 is a block diagram showing example components of a display of the electronic device of FIG. 4, in accordance with some aspects of the disclosure.

FIG. 6 is a perspective illustration of a transparent emissive layer and an electrophoretic layer of the display of FIG. 5, in accordance with some aspects of the disclosure.

FIG. 7 is a flow diagram illustrating an example process for presenting content on a display of an electronic device, in accordance with some aspects of the disclosure.

### DETAILED DESCRIPTION

Electronic devices, including various types of portable electronic devices, can perform a variety of functions that consume significant amounts of power. For example, electronic devices presenting video content on an electronic display (also referred to as a display) can use a significant amount of power. Moreover, certain types of high-quality displays can consume even more power than other types of displays. For example, organic light-emitting diode (OLED) displays can provide high levels of contrast and the ability to be transparent, but they use a constant voltage applied across electrodes to maintain pixel states. The constant application of this voltage can drain the battery of the electronic device on which the OLED display is installed. Therefore, the user may be required to charge the electronic device more frequently than desired. Other types of emissive displays can likewise consume significant amounts of power when presenting content such as, for example, videos and images.

To reduce the amount of power draw by an emissive display such as, for example, an OLED display, a stacked display can be used. The stacked display can include both a transparent emissive layer and an electrophoretic layer. The transparent emissive layer and an electrophoretic layer can be individually addressable. The stacked display can receive content (e.g., video content) and separate the content into active content and passive content. Then, the stacked display can present the active content via the transparent emissive layer and present the passive content via the electrophoretic layer. The electrophoretic layer requires less power to present content because it does not require a constant voltage to be applied to maintain pixel states. Moreover, due to the transparent nature of the transparent emissive layer, privacy functionality can be enabled for various software applications using the layered display. Additionally, software developers can design software applications that leverage the layered display to direct user focus to different areas of the display.

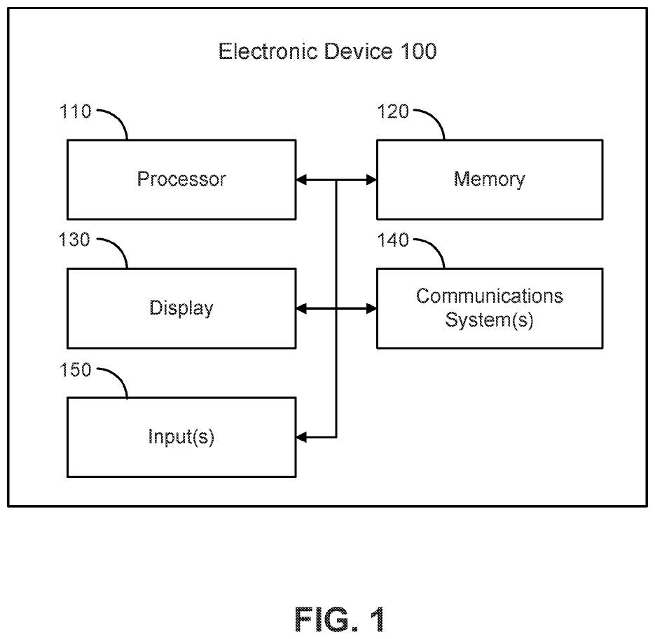

Referring to FIG. 1, a block diagram showing example components of an example electronic device 100 is shown. The electronic device 100 is shown to include a processor 110, a memory 120, a display 130, communication system(s) 140, and input(s) 150. The electronic device 100 can be powered in a variety of ways, including being powered by a battery or another source of power. The electronic device 100 can be a variety of different types of electronic devices, such as, for example, a smartphone, a tablet, a wearable device, a laptop, a workstation, a desktop computer, a personal computer, all-in-one computer, a notebook, a television, a monitor, or another type of electronic device. As detailed below, the display 130 of the electronic device 100 can be implemented using stacked display layers to reduce overall power consumption of the electronic device 100. The display 130 can also include a single hybrid timing controller for addressing both of the stacked display layers.

The processor 110 can be implemented using a suitable hardware processor or combination of processors, including using central processing units (CPU), graphics processing units (GPU), and/or other types of hardware processing components. The processor 110 can further be implemented using a suitable number of processing cores, including single core processors, dual core processors, and other processor core configurations. The processor 110 can generally execute machine-readable instructions to perform various operations for the electronic device 100. For example, the processor 110 can execute an operating system as well as various software applications to receive, generate, and ultimately cause content to be presented to a user of the electronic device via the display 130.

The memory 120 can include a suitable storage device or devices that can be used to store machine-readable instructions, values, etc., that can be used, for example, by the processor 110 to present content using display 130, to communicate with other computing devices, and to perform various other operations. The memory 120 can include suitable types of memory including volatile memory, non-volatile memory, storage, or a suitable combination thereof. For example, the memory 120 can include random-access memory (RAM), read-only memory (ROM), electrically erasable programmable read-only memory (EEPROM), one or more flash drives, one or more hard disks, one or more solid state drives, one or more optical drives, and the like. The memory 120 can include non-transitory computer readable storage media having instructions stored thereon for execution by processor 110 to implement various operations using the electronic device 100. The processor 110 can execute different programs stored in the memory 120 to transmit information and/or content (e.g., results of a database query, a portion of a user interface, textual information, graphics, and the like) to different computing devices and systems, receive information and/or content from different computing devices and systems, receive instructions from different computing devices and systems, and other types of operations.

The communications systems 140 can include a suitable hardware, firmware, and/or software for communicating information over suitable types of communication networks, including local networks, external networks, the Internet, and other types of networks for accessing by the electronic device 100. For example, the communications systems 140 can include one or more transceivers, one or more communication chips and/or chip sets, one or more antennas and/or radios, and other suitable types of electronic communication components that facilitate electronic communications. For example, the communications systems 140 can include hardware, firmware, and/or software that can be used to establish a Wi-Fi connection, a Bluetooth connection, a cellular network connection, an Ethernet connection, and/or other similar types of connections.

The inputs 150 can include suitable input devices and/or sensors used to provide input or inputs to the electronic device 100. For example, the inputs 150 can include one or more microphones, cameras, keyboards, keypads, mice, touchpads, biometric readers (e.g., fingerprint sensors, eye scanners, etc.), and other components that can be used to provide input to the electronic device 100. A user associated with the electronic device 100 can also provide inputs to the electronic device 100 via the display 130, for example when the display 130 is or includes a touchscreen or touch-sensitive components. The user associated with the electronic device 100 can provide inputs to launch a software application, for example, that launches video content to be displayed via the display 130.

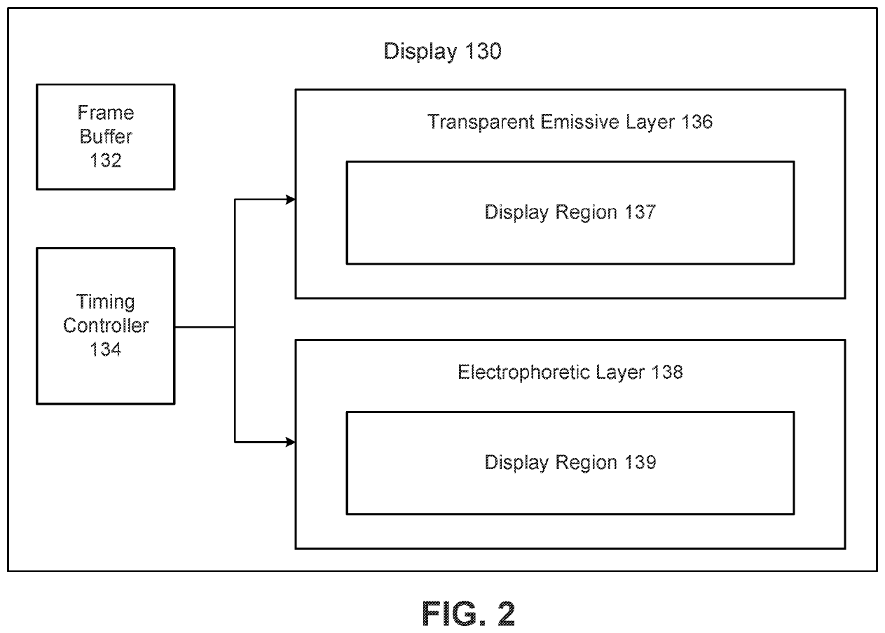

Referring to FIG. 2, a block diagram showing example components of the display 130 of the electronic device 100 is shown. As illustrated, the display 130 includes a frame buffer 132, a timing controller 134, a transparent emissive layer 136, a display region 137, an electrophoretic layer 138, and a display region 139. The display region 137 is associated with the transparent emissive layer 136 and the display region 139 is associated with the electrophoretic layer 138. The components of the display 130 as shown in FIG. 2 are provided as examples, and the display 130 can include additional, fewer, and/or alternative components relative to the components expressly shown in FIG. 2. For example, the display 130 can include processing components, memory components, etc. depending on the application.

The frame buffer 132 (sometimes referred to as a framestore, a frame buffer, etc.) can be implemented in a variety of manners and generally stores data representing pixels for display via the display 130. For example, the frame buffer 132 can contain data representing all of the pixels in a complete video frame. The frame buffer 132 can be implemented in circuitry of the memory 120. For example, the frame buffer 132 can be implemented as a memory buffer in random-access memory of a video card or other types of graphics card. The circuitry of the frame buffer 132 can convert a bitmap into a video signal that drives the display 130. Content signals provided as input to the display 130 can be stored as frames of content in the frame buffer 132. Then, the frames of content in the frame buffer 132 can be analyzed to identify active regions and passive regions of pixels.

The timing controller 134 can be implemented in a variety of ways and generally provides addressing functionality for both the transparent emissive layer 136 and the electrophoretic layer 138. In this sense, the timing controller 134 can be viewed as a hybrid-designed timing controller that separately addresses the pixels of the transparent emissive layer 136 and the electrophoretic layer 138 in parallel. The timing controller 134 can be any portion of a circuit that generates control signals, synchronization signals, and/or clock signals, whether that is independently or in conjunction with other circuitry or devices, as used for interfacing with the transparent emissive layer 136 and the electrophoretic layer 138. The timing controller 134 can be used for bit compensation to adjust contrast, brightness, color, overdrive, and other functions for interfacing with the transparent emissive layer 136 and the electrophoretic layer 138.

The timing controller 134 can be configured to separate content stored in the frame buffer 132 into active content and passive content. Passive content generally represents content that does not change or changes minimally over a period of time. For example, passive content can include background content in a video (e.g., the sky, a wall of a room, a floor of a room, a ceiling of a room, a table, the interior of a vehicle, etc.) and other video content that does not include significant changes in pixel values over a period of time (e.g., above a certain threshold) to present via the display 130. Active content generally represents content that does change or changes above a certain threshold amount over a period of time. For example, active content can include foreground content in a video (e.g., people, moving objects, etc.) and other video content that does include significant changes in pixel values over a period of time to present via the display 130. The time period used for determining whether content is active content or passive content can vary depending on the type of device and/or the type of content (e.g., 1 second, 15 seconds, 1 minute, etc.). The timing controller 134 can identify pixels and/or groups of pixels (regions) as active and passive in a variety of manners. For example, the timing controller 134 can implement thresholds (e.g., threshold percentage changes, threshold value changes, etc.), rules, model(s), and other types of approaches to analyzing content for presentation via the display 130. A tagging scheme can be implemented such that the timing controller 134 tags active pixels as active and passive pixels as passive.

The transparent emissive layer 136 can be implemented in a variety of manners, including using different types of transparent emissive layers. For example, the transparent emissive layer 136 can be an OLED layer, a micro-LED layer, or other types of emissive display layers. The transparent emissive layer 136 can include different materials and sub-layers such as, for example, various types of small molecules, polymers, mobile ions, organic compounds, electroluminescent materials, and the like. The transparent emissive layer 136 can provide dynamic, high quality content display with high definition and high levels of contrast. The user of the electronic device 100 can view content presented via the transparent emissive layer 136 as such. The transparent emissive layer 136 can also be made transparent or at least partially transparent such that the user can see through the transparent emissive layer 136.

The transparent emissive layer 136 includes a display region 137, where the display region 137 includes a collection of pixels for displaying content via the transparent emissive layer 136. The display region 137 can generally be formed using a variety of different resolutions, such as, for example, a resolution of 1,280×768 pixels, a resolution of 3,840 pixels×2,160 pixels, and other possible resolutions. The display region 137 can also be formed using a variety of different refresh rates, such as, for example, a 120 Hertz refresh rate, a 60 Hertz refresh rate, a 144 Hertz refresh rate, and other possible refresh rates. The refresh rate of the display region 137 can be higher than the refresh rate of the display region 139 comparatively. The display region 137 can generally have a matching resolution as the display region 139. In this way, due to the matching resolutions of the display region 137 and the display region 139 (1:1 pixel ratio), the display 130 as a whole can advantageously appear to the user of the electronic device 100 as a display of a known resolution. Accordingly, the display 130 can provide content in a “smooth” manner overall that does not appear patchy, segregated, or otherwise degraded to the user of the electronic device 100. The display region 137 can include all of the pixels of the transparent emissive layer 136 or only a subset of the pixels of the transparent emissive layer 136.

The electrophoretic layer 138 can be implemented in a variety of manners, including using different types of electrophoretic layers. For example, the electrophoretic layer can be an E-Ink (electronic paper, electronic ink, e-paper, etc.) layer or another type of electrophoretic display layer. The electrophoretic layer 138 can be a color display layer or a grayscale display layer. The electrophoretic layer 138 can include different materials and sub-layers such as, for example, charged pigments, micro-capsules, supporting layers, and the like. The electrophoretic layer 138 can present content in a low-power consuming manner, for example because no constant voltage may be used to present content via the electrophoretic layer 138. Moreover, since passive content may be presented via the electrophoretic layer 138, the quality of the content presented via the electrophoretic layer 138 is less important or non-important altogether. For example, the user of the electronic device 100 may not even be able to notice a difference in terms of content presentation quality for passive content presented via the electrophoretic layer 138 and passive content presented via the transparent emissive layer 136.

The electrophoretic layer 138 includes a display region 139, where the display region 139 includes a collection of pixels for displaying content via the electrophoretic layer 138. The display region 139 can generally be formed using a variety of different resolutions, such as, for example, a resolution of 1,280×768 pixels, a resolution of 3,840 pixels×2,160 pixels, and other possible resolutions. The display region 139 can also be formed using a variety of different refresh rates, such as, for example, a 120 Hertz refresh rate, a 60 Hertz refresh rate, a 30 Hertz refresh rate, and other possible refresh rates. The display region 139 can generally have a matching resolution as the display region 137, as noted. In this way, due to the matching resolutions of the display region 137 and the display region 139 (1:1 pixel ratio), the display 130 as a whole can advantageously appear to the user of the electronic device 100 as a display of a known resolution such that it does not appear patchy, segregated, or otherwise degraded to the user of the electronic device 100. The display region 139 can include all of the pixels of the electrophoretic layer 138 or only a subset of the pixels of the electrophoretic layer 138.

The presentation of content via the transparent emissive layer 136 can use significant power consumption by the electronic device 100. For example, a constant voltage may need to be provided across a pair of electrodes to maintain and/or change pixel states for pixels in the transparent emissive layer 136. Accordingly, the timing controller 134 can present the active content via the transparent emissive layer 136, but present the passive content via the electrophoretic layer 138. For example, the timing controller 134 can identify one or more active regions of the content in the frame buffer 132 and one or more passive regions of the content in the frame buffer 132. Each active region can be associated with a grouping of active pixels and each passive region can be associated with a grouping of passive pixels. For the transparent emissive layer 136, the timing controller 134 can cause the active pixels to display the active content (e.g., address each the active pixels as a specific pixel value, such as, for example, a RGB or RGBA values) and cause the passive pixels to be transparent. For the electrophoretic layer 138, the timing controller 134 can cause the active pixels to be black (e.g., addressed as black, turned off) and cause the passive pixels to be turned on (e.g., addressed as a specific RGB value, turned on).

If a certain time period elapses where the pixel value of an active pixel does not change (e.g., the content presented via the pixel does not change for a period of 1 second, a period of 5 seconds, etc.), the pixel can be re-classified as a static pixel (or passive pixel) instead of an active pixel. As such, the timing controller 134 can, effectively, move the static pixel from the transparent emissive layer 136 to the electrophoretic layer 138 (e.g., without the user noticing). Also, in some examples, the operating system of the electronic device 100 and/or the timing controller 134 can convert content received by the display 130 and stored in the frame buffer 132 between different formats for compatibility with the transparent emissive layer 136 that is disposed over the electrophoretic layer 138. For example, if the received content is designed for display via a format compatible with the transparent emissive layer 136 (e.g., a format compatible with OLED display technology), the operating system of the electronic device 100 and/or the timing controller 134 can convert the content such that it is compatible for display via the electrophoretic layer 138 (e.g., so that it is formatted for use with E-Ink display technology).

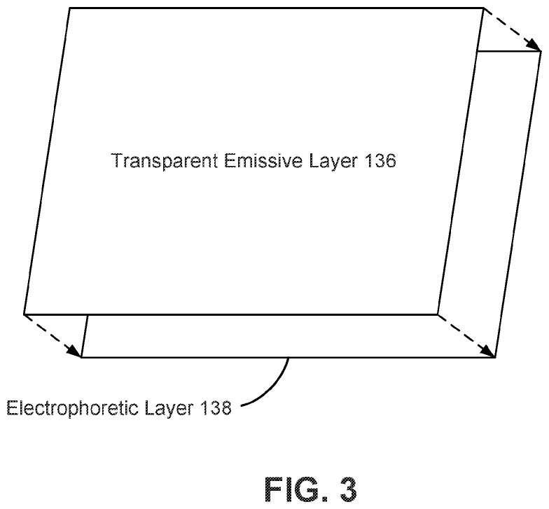

Referring to FIG. 3, a perspective illustration of the transparent emissive layer 136 and the electrophoretic layer 138 of the display 130 of the electronic device 100 is shown. As illustrated, the transparent emissive layer 136 is formed such that the transparent emissive layer 136 is disposed over the electrophoretic layer 138. The pixels in the display region 137 of the transparent emissive layer 136 corresponding to passive pixels (pixels determined to be passive pixels) can be caused to be transparent. As a result, a user of the electronic device 100 sees through the passive region(s) of the transparent emissive layer 136 to the electrophoretic layer 138. The passive pixels in the display region 139 of the electrophoretic layer 138 can then be caused to be black such that the user of the electronic device 100 sees only the black pixels of the electrophoretic layer 138 in the passive region(s) of the electrophoretic layer 138.

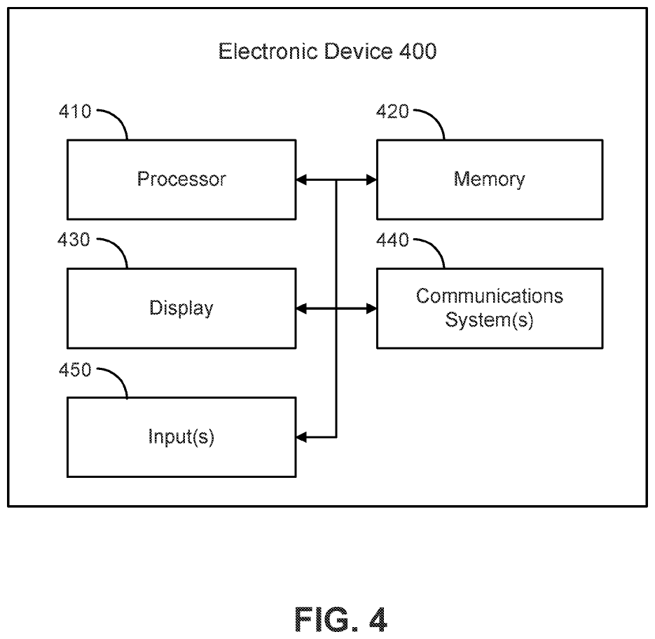

Referring to FIG. 4, a block diagram showing example components of an electronic device 400 is shown. The electronic device 400 is shown to include a processor 410, a memory 420, a display 430, communication system(s) 440, and input(s) 450. The electronic device 400 can be powered in a variety of ways, including being powered by a battery or another source of power. The electronic device 400 can be implemented as a variety of different types of electronic devices, such as, for example, a smartphone, a tablet, a wearable device, a laptop, a workstation, all-in-one computer, a notebook, a desktop computer, a personal computer, a television, a monitor, or another type of electronic device. As detailed below, the display 430 of the electronic device 400 can be implemented using stacked display layers to reduce overall power consumption of the electronic device 400. The display 430 can also include separate timing controllers for addressing each of the stacked display layers.

The processor 410 can be implemented using a suitable hardware processor or combination of processors, including using CPUs, GPUs, and/or other types of hardware processing components. The processor 410 can further be implemented using a suitable number of processing cores, including single core processors, dual core processors, and other processor core configurations. The processor 410 can generally execute machine-readable instructions to perform various operations for the electronic device 400. For example, the processor 410 can execute an operating system as well as various software applications to receive, generate, and ultimately cause content to be presented to a user of the electronic device via the display 430.

The memory 420 can include a suitable storage device or devices that can be used to store machine-readable instructions, values, etc., that can be used, for example, by the processor 410 to present content using display 430, to communicate with other computing devices, and to perform various other operations. The memory 420 can include suitable types of memory including volatile memory, non-volatile memory, storage, or a suitable combination thereof. For example, the memory 420 can include RAM, ROM, EEPROM, one or more flash drives, one or more hard disks, one or more solid state drives, one or more optical drives, and the like. The memory 420 can include non-transitory computer readable storage media having instructions stored thereon for execution by processor 410 to implement various operations using the electronic device 400. The processor 410 can execute different programs stored in the memory 420 to transmit information and/or content (e.g., results of a database query, a portion of a user interface, textual information, graphics, and the like) to different computing devices and systems, receive information and/or content from different computing devices and systems, receive instructions from different computing devices and systems, and other types of operations.

The communications systems 440 can include suitable hardware, firmware, and/or software for communicating information over suitable types of communication networks, including local networks, external networks, the Internet, and other types of networks for accessing by the electronic device 400. For example, the communications systems 440 can include one or more transceivers, one or more communication chips and/or chip sets, one or more antennas and/or radios, and other suitable types of electronic communication components that facilitate electronic communications. For example, the communications systems 440 can include hardware, firmware, and/or software that can be used to establish a Wi-Fi connection, a Bluetooth connection, a cellular network connection, an Ethernet connection, and/or other similar types of connections.

The inputs 450 can include suitable input devices and/or sensors used to provide input or inputs to the electronic device 400. For example, the inputs 450 can include one or more microphones, cameras, keyboards, keypads, mice, touchpads, biometric readers (e.g., fingerprint sensors, eye scanners, etc.), and other components that can be used to provide input to the electronic device 400. A user associated with the electronic device 400 can also provide inputs to the electronic device 400 via the display 430, for example when the display 430 is or includes a touchscreen or touch-sensitive components. The user associated with the electronic device 400 can provide inputs to launch a software application, for example, that launches video content to be displayed via the display 430.

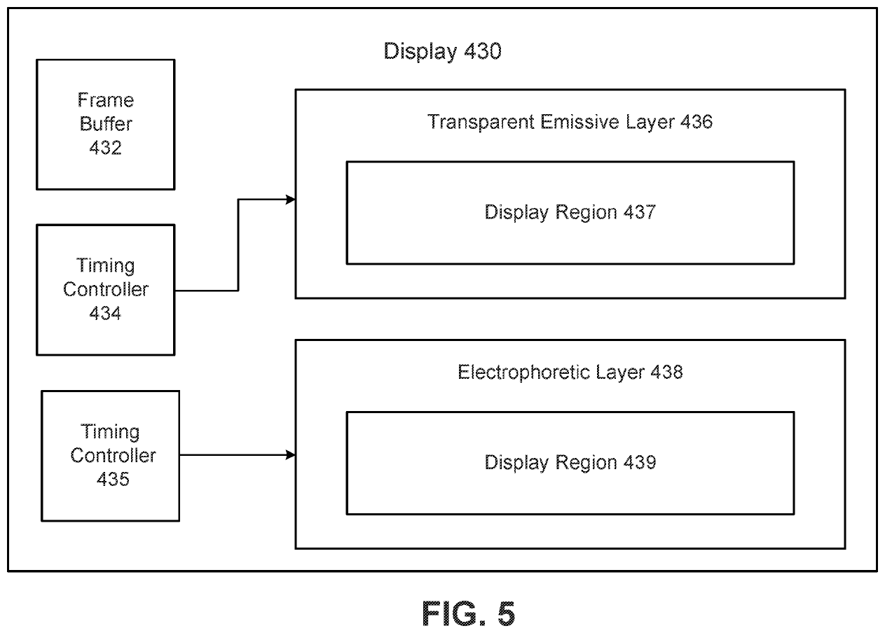

Referring to FIG. 5, a block diagram showing example components of the display 430 of the electronic device 400 is shown. As illustrated, the display 430 includes a frame buffer 432, a first timing controller 434, a second timing controller 435, a transparent emissive layer 436, a display region 437, an electrophoretic layer 438, and a display region 439. The display region 437 is associated with the transparent emissive layer 436 and the display region 439 is associated with the electrophoretic layer 438. The components of the display 430 as shown in FIG. 5 are provided as examples, and the display 430 can include additional, fewer, and/or alternative components relative to the components expressly shown in FIG. 5. For example, the display 430 can include processing components, memory components, etc. depending on the application.

The frame buffer 432 can be implemented in a variety of manners and generally stores data representing pixels for display via the display 430. For example, the frame buffer 432 can contain data representing all of the pixels in a complete video frame. The frame buffer 432 can be implemented in circuitry of the memory 420 or can be implemented otherwise. For example, the frame buffer 432 can be implemented as a memory buffer in random-access memory of a video card or other types of graphics card. The circuitry of the frame buffer 432 can convert a bitmap into a video signal that drives the display 430. Content signals provided as input to the display 430 can be stored as frames of content in the frame buffer 432. Then, the frames of content in the frame buffer 432 can be analyzed to identify active regions and passive regions of pixels.

The first timing controller 434 can be implemented in a variety of ways and generally provides addressing functionality for the transparent emissive layer 436. The first timing controller 434 can be implemented as any portion of a circuit that generates control signals, synchronization signals, and/or clock signals, whether independently or in conjunction with other circuitry or devices, as used for interfacing with the transparent emissive layer 436. The first timing controller 434 can be used for bit compensation to adjust contrast, brightness, color, overdrive, and other functions for interfacing with the transparent emissive layer 436.

The second timing controller 435 can be implemented in a variety of ways and generally provides addressing functionality for the electrophoretic layer 438. The second timing controller 435 can be implemented as any portion of a circuit that generates control signals, synchronization signals, and/or clock signals, whether independently or in conjunction with other circuitry or devices, as used for interfacing with the electrophoretic layer 438. The second timing controller 435 can be used for bit compensation to adjust contrast, brightness, color, overdrive, and other functions for interfacing with the electrophoretic layer 438. Accordingly, the first timing controller 434 and the second timing controller 435 can separately address the transparent emissive layer 436 and the electrophoretic layer 438, respectively, in parallel.

The transparent emissive layer 436 can be implemented in a variety of manners, including using different types of transparent emissive layers. For example, the transparent emissive layer 436 can be an OLED layer, a micro-LED layer, or other types of emissive display layers. The transparent emissive layer 436 can include different materials and sub-layers such as, for example, various types of small molecules, polymers, mobile ions, organic compounds, electroluminescent materials, and the like. The transparent emissive layer 436 can provide dynamic, high quality content display with high definition and beautiful contrast. The user of the electronic device 400 can view content presented via the transparent emissive layer 436 as such. The transparent emissive layer 436 can also be made transparent or at least partially transparent such that the user can see through the transparent emissive layer 436.

The transparent emissive layer 436 includes a display region 437, where the display region 437 includes a collection of pixels for displaying content via the transparent emissive layer 436. The display region 437 can generally be formed using a variety of different resolutions, such as, for example, a resolution of 1,280×768 pixels, a resolution of 3,840 pixels×2,160 pixels, and other possible resolutions. The display region 437 can also be formed using a variety of different refresh rates, such as, for example, a 60 Hertz refresh rate, a 120 Hertz refresh rate, a 144 Hertz refresh rate, and other possible refresh rates. The display region 437 can generally have a matching resolution as the display region 439. In this way, due to the matching resolutions of the display region 437 and the display region 439 (1:1 pixel ratio), the display 430 as a whole can advantageously appear to the user of the electronic device 400 as a display of a known resolution. Accordingly, the display 430 can provide content in a smooth manner overall that does not appear patchy, segregated, or otherwise degraded to the user of the electronic device 400. The display region 437 can include all of the pixels of the transparent emissive layer 436 or only a subset of the pixels of the transparent emissive layer 436.

The electrophoretic layer 438 can be implemented in a variety of manners, including using different types of electrophoretic layers. For example, the electrophoretic layer can be an E-Ink layer or another type of electrophoretic display layer. The electrophoretic layer 438 can be a color display layer or a grayscale display layer. The electrophoretic layer 438 can include different materials and sub-layers such as, for example, charged pigments, micro-capsules, supporting layers, and the like. The electrophoretic layer 438 can present content in a low-power consuming manner, for example because no constant voltage may be used to present content via the electrophoretic layer 438. Moreover, since passive content may be presented via the electrophoretic layer 438, the quality of the content presented via the electrophoretic layer 438 is less important or non-important altogether. For example, the user of the electronic device 400 may not be able to notice a difference in terms of content presentation quality for passive content presented via the electrophoretic layer 438 and passive content presented via the transparent emissive layer 436.

The electrophoretic layer 438 includes a display region 439, where the display region 439 includes a collection of pixels for displaying content via the electrophoretic layer 438. The display region 439 can generally be formed using a variety of different resolutions, such as, for example, a resolution of 1,280×768 pixels, a resolution of 3,840 pixels×2,160 pixels, and other possible resolutions. The display region 439 can also be formed using a variety of different refresh rates, such as, for example, a 120 Hertz refresh rate, a 60 Hertz refresh rate, a 30 Hertz refresh rate, and other possible refresh rates. The display region 439 can generally have a matching resolution as the display region 437, as noted. In this way, due to the matching resolutions of the display region 437 and the display region 439 (1:1 pixel ratio), the display 430 as a whole can advantageously appear to the user of the electronic device 100 as a display of a known resolution such that it does not appear patchy, segregated, or otherwise degraded to the user of the electronic device 400. The display region 439 can include all of the pixels of the electrophoretic layer 438 or only a subset of the pixels of the electrophoretic layer 438.

The presentation of content via the transparent emissive layer 436 can use significant power consumption by the electronic device 400. For example, a constant voltage may need to be provided across a pair of electrodes to maintain and/or change pixel states for pixels in the transparent emissive layer 436. Accordingly, the first timing controller 434 can present the active content via the transparent emissive layer 436, but the second timing controller 435 can present the passive content via the electrophoretic layer 438. For example, the first timing controller 434 and/or the second timing controller 435 can identify one or more active regions of the content in the frame buffer 432 and one or more passive regions of the content in the frame buffer 432. Each active region can be associated with a grouping of active pixels and each passive region can be associated with a grouping of passive pixels. For the transparent emissive layer 436, the first timing controller 434 can cause the active pixels to display the active content (e.g., address each the active pixels as a specific pixel value, such as, for example, a RGB or RGBA values) and cause the passive pixels to be transparent. For the electrophoretic layer 438, the second timing controller 435 can cause the active pixels to be black (e.g., addressed as black, turned off) and cause the passive pixels to be turned on (e.g., addressed as a specific RGB value, turned on).

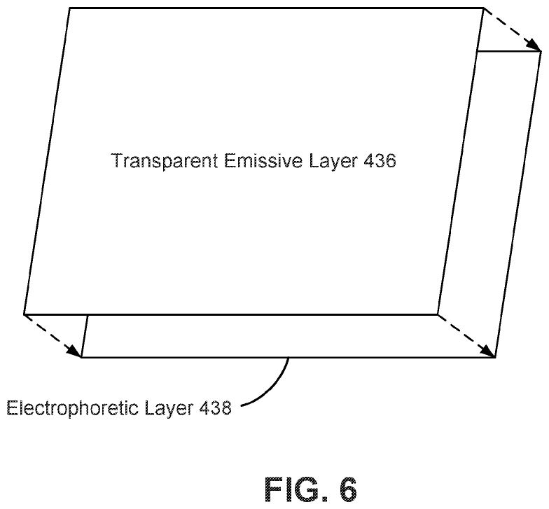

Referring to FIG. 6, a perspective illustration of the transparent emissive layer 436 and the electrophoretic layer 438 of the display 430 of the electronic device 400 is shown. As illustrated, the transparent emissive layer 436 is formed such that the transparent emissive layer 436 is disposed over the electrophoretic layer 438. The pixels in the display region 437 of the transparent emissive layer 436 corresponding to passive pixels (pixels determined to be passive pixels) can be caused to be transparent. As a result, a user of the electronic device 400 sees through the passive region(s) of the transparent emissive layer 436 to the electrophoretic layer 438. The passive pixels in the display region 439 of the electrophoretic layer 438 can then be caused to be black such that the user of the electronic device 400 sees only the black pixels of the electrophoretic layer 438 in the passive region(s) of the electrophoretic layer 438.

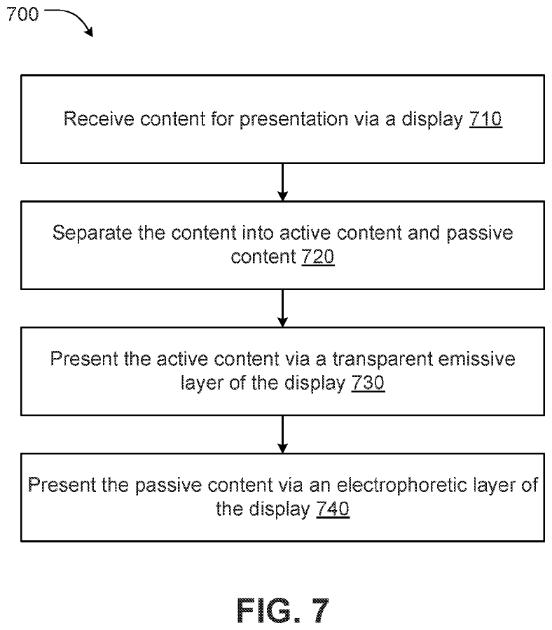

Referring to FIG. 7, a flow diagram showing an example process 700 for presenting content on a display of an electronic device is shown. The process 700 can be performed by the electronic device 100 or the electronic device 400, for example. The process 700 can be used to provide high quality display on electronic devices such as, for example, smartphones, tablets, wearable devices, laptops, workstations, all-in-one computer, desktop computers, personal computers, notebooks, televisions, monitors, and other types of electronic devices. The process 700 generally separates content (e.g., video content) into passive content and active content. Then, the process 700 presents the active content via a transparent emissive display layer and presents the passive content via an electrophoretic display layer.

At 710, the process 700 can receive content for presentation via a display. For example, an electronic device can receive video content for presentation via the display. In some examples, the electronic device 100 can receive video content for presentation via the display 130. The electronic device 100 can store the content at least temporarily in the frame buffer 132. In some examples, the electronic device 400 can receive video content for presentation via the display 430. The electronic device 400 can store the content at least temporarily in the frame buffer 432. The video content may include a video stream, images (e.g., a slideshow of images, etc.), virtual reality (VR) content, augmented reality (AR) content, a combination thereof, and other types of electronic content that may be displayed to a user.

At 720, the process 700 can separate the content into active content and passive content. For example, a timing controller can separate the content into active content and passive content. In some examples, the timing controller 134 separates the content stored in the frame buffer 132 into active content and passive content. In some examples, the first timing controller 434 and/or the second timing controller 435 separates the content stored in the frame buffer 432 into active content and passive content. As described above, passive content generally represents content that does not change or changes minimally (e.g., below a certain threshold) over a period of time. For example, passive content can include background content in a video and other video content that does not include significant changes in pixel values over a period of time. Active content generally represents content that does change or changes above a certain threshold amount over a period of time. For example, active content can include foreground content in a video and other video content that does include significant changes in pixel values over a period of time.

The timing controller can identify pixels as active and passive in a variety of manners, for example using thresholds, rules, model, and other approaches. In some examples, in block 720, the timing controller (e.g., timing controller 134, 434, and/or 435) may implement a tagging scheme such that the timing controller analyzes the content in the frame buffer 132 and tags active pixels in the frame buffer as active and passive pixels in the frame buffer as passive. For example, for each pixel, the timing controller may analyze pixel values over a time period. For example, when the amount of variance of the pixel values over the time period for a particular pixel exceeds an active variance threshold, the timing controller can tag the pixel as active. Similarly, when the amount of variance of the pixel values over the time period for a particular pixel is below a passive variance threshold, the timing controller can tag the pixel as passive. In some examples, the timing controller analyzes a subset of pixels at a time (e.g., four pixels, nine pixels, etc.) rather than a single pixel at a time, comparing the variance of the subset of pixels over a time period to respective passive and active variance thresholds to determine whether to tag the subset as active or passive.

The time period used for determining whether content for a pixel is active content or passive content can vary depending on the type of device and/or the type of content. In some examples, a timer or clock (e.g., used or implemented by the timing controller) obtains the time period to use in this determination from a memory (e.g., the memory 120 or 420).

At 730, the process 700 can present the active content via a transparent emissive layer of the display. For example, a timing controller can present the active content via a transparent emissive layer of the display. In some examples, the timing controller 134 can present the active content via the transparent emissive layer 136. In some examples, the first timing controller 434 can present the active content via the transparent emissive layer 436. The active content may include identifiers for each active pixel and corresponding pixel values for each active pixel. The identifiers may identify the active pixels, respectively, by a location in a pixel array of the transparent emissive layer (e.g., in terms of an x, y position in the array). The identifiers may be explicit identifiers or may be implicit identifiers (e.g., a pixel's position may be implied by a position of a corresponding pixel value, tag, or other data in an array of data). Each pixel value may indicate a control signal for an active pixel to achieve a desired visual output by the active pixel. Accordingly, in some examples, to present the active content, the timing controller may control the active pixels of the transparent emissive layer according to identifiers and corresponding pixel values of the active content.

At 740, the process 700 can present the passive content via an electrophoretic layer of the display. For example, a timing controller can present the passive content via an electrophoretic layer of the display. In some examples, the timing controller 134 can present the passive content via the electrophoretic layer 138. In some examples, the second timing controller 436 can present the passive content via the electrophoretic layer 438.

The passive content may include identifiers for each passive pixel and corresponding pixel values for each passive pixel. The identifiers may identify the passive pixels, respectively, by a location in a pixel array of the electrophoretic layer (e.g., in terms of an x, y position in the array). The identifiers may be explicit identifiers or may be implicit identifiers (e.g., a pixel's position may be implied by a position of a corresponding pixel value, tag, or other data in an array of data). Each pixel value may indicate a control signal for a passive pixel to achieve a desired visual output by the passive pixel. Accordingly, in some examples, to present the passive content, the timing controller may control the passive pixels of the transparent emissive layer according to identifiers and corresponding pixel values of the passive content.

Accordingly, power savings for the electronic device can be achieved because a constant voltage may not be applied across the entire transparent emissive layer of the display during the entire time period the display is outputting or displaying content. Moreover, due to the transparent nature of the transparent emissive layer, privacy functionality can be enabled for various software applications using the layered display. Additionally, software developers can design applications that leverage the layered display to direct user focus to different areas of the display.

In some examples, in block 730, in addition to presenting the active content via the active pixels of the transparent emissive layer, the timing controller (e.g., the timing controller 134, 434, 435) causes the passive pixels of the transparent emissive layer to be transparent. For example, as noted, the passive content may include identifiers for each passive pixel and corresponding pixel values for each passive pixel. The corresponding pixel values may include pixel values for the passive pixel on both the transparent emissive layer of the display and for the electrophoretic layer of the display. The pixel values for the passive pixels on the transparent emissive layer may indicate a control signal for the passive pixels to be transparent.

In some examples, in block 740, in addition to presenting the passive content via the passive pixels of the electrophoretic layer, the timing controller (e.g., the timing controller 134, 434, 435) causes the active pixels of the electrophoretic layer to be black. For example, as noted, the active content may include identifiers for each active pixel and corresponding pixel values for each active pixel. The corresponding pixel values may include pixel values for the active pixel on both the transparent emissive layer of the display and for the electrophoretic layer of the display. The pixel values for the active pixels on the transparent emissive layer may indicate a control signal for the active pixels to be black.

In some examples of the process 700, if a certain time period elapses where the pixel value of an active pixel does not change (e.g., a time period of 1 second, a time period of 5 seconds, etc.), the pixel can be re-classified as a static pixel (or passive pixel) instead of an active pixel. As such, the pixel can be, effectively, moved from the transparent emissive layer to the electrophoretic layer (e.g., without the user noticing).

Although the process 700 is described with respect to the electronic device 100 and the electronic device 400, in some examples, the process 700 may be performed by other systems and devices with additional, fewer, or different configurations and components. Additionally, one or more of the blocks of the process 700 may be executed in a different order than illustrated and/or in parallel or partially in parallel with one another.

In some examples, aspects of the technology, including computerized implementations of methods according to the technology, can be implemented as a system, method, apparatus, or article of manufacture using standard programming or engineering techniques to produce software, firmware, hardware, or a combination thereof to control a processor, also referred to as an electronic processor, (e.g., a serial or parallel processor chip or specialized processor chip, a single-or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein. Accordingly, for example, examples of the technology can be implemented as a set of instructions, tangibly embodied on a non-transitory computer-readable media, such that a processor can implement the instructions based upon reading the instructions from the computer-readable media. Some examples of the technology can include (or utilize) a control device such as, e.g., an automation device, a special purpose or programmable computer including various computer hardware, software, firmware, and so on, consistent with the discussion herein. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the figures, or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of”. Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of”.

Although the present technology has been described by referring to certain examples, workers skilled in the art will recognize that changes can be made in form and detail without departing from the scope of the discussion.

1. An electronic device, comprising:
memory;
a display comprising both a transparent emissive layer having a first display region and an electrophoretic layer having a second display region, the first display region and the second display region having matching resolutions, and the transparent emissive layer and the electrophoretic layer being individually addressable;
a processor coupled to the memory and to the display and configured to execute machine-readable instructions stored in the memory to:
receive content for presentation via the display;
separate the content into active content and passive content;
present the active content via the transparent emissive layer; and
present the passive content via the electrophoretic layer.

2. The device of claim 1, wherein the transparent emissive layer is formed such that the transparent emissive layer is disposed over the electrophoretic layer.

3. The device of claim 1, wherein the processor is configured to execute the machine-readable instructions to separate the content into active content and passive content by identifying pixels as active pixels or passive pixels.

4. The device of claim 3, wherein the processor is configured to execute the machine-readable instructions to:
present the active content via the active pixels of the transparent emissive layer; and
cause the passive pixels of the transparent emissive layer to be transparent.

5. The device of claim 4, wherein the processor is configured to execute the machine-readable instructions to:
present the passive content via the passive pixels of the electrophoretic layer; and
cause the active pixels of the electrophoretic layer to be black.

6. The device of claim 1, wherein the display comprises a timing controller comprising circuitry configured to address both the transparent emissive layer and the electrophoretic layer.

7. The device of claim 1, wherein the display comprises:
a first timing controller comprising circuitry configured to address the transparent emissive layer; and
a second timing controller comprising circuitry configured to address the electrophoretic layer.

8. The device of claim 1, wherein the transparent emissive layer comprises an organic light-emitting diode (OLED) layer and the electrophoretic layer comprises an E-Ink layer.

9. A method for presenting content on a display of an electronic device, comprising:
receiving content for presentation via the display;
separating the content into active content and passive content;
presenting the active content via a first display region of a transparent emissive layer of the display of the electronic device; and
presenting the passive content via a second display region of an electrophoretic layer of the display of the electronic device;
wherein the first display region and the second display region have matching resolutions, and the transparent emissive layer and the electrophoretic layer are individually addressable.

10. The method of claim 9, wherein separating the into active content and passive content comprises identifying pixels as active pixels or passive pixels.

11. The method of claim 10, comprising:
presenting the active content via the active pixels of the transparent emissive layer; and
causing the passive pixels of the transparent emissive layer to be transparent.

12. The method of claim 11, comprising:
presenting the passive content via the passive pixels of the electrophoretic layer; and
causing the active pixels of the electrophoretic layer to be black.

13. The method of claim 9, wherein:
the transparent emissive layer comprises an organic light-emitting diode (OLED) layer;
the electrophoretic layer comprises an E-Ink layer; and
the transparent emissive layer is disposed over the electrophoretic layer.

14. An electronic display system, comprising:
a transparent emissive display layer having a first display region;
an electrophoretic layer having a second display region, the first display region and the second display region having matching resolutions, and the transparent emissive layer and the electrophoretic layer being individually addressable;
a timing controller comprising circuitry configured to address both the transparent emissive layer and the electrophoretic layer;
a processor configured to execute machine-readable instructions to:
receive content for presentation via the display;
separate the content into active content and passive content;
present the active content via the transparent emissive layer; and
present the passive content via the electrophoretic layer.

15. The system of claim 14, wherein the transparent emissive layer is formed such that the transparent emissive layer is disposed over the electrophoretic layer.

16. The system of claim 14, wherein the processor is configured to execute the machine-readable instructions to separate the content into active content and passive content by identifying pixels as active pixels or passive pixels.

17. The system of claim 16, wherein the processor is configured to execute the machine-readable instructions to:
present the active content via the active pixels of the transparent emissive layer; and
cause the passive pixels of the transparent emissive layer to be transparent.

18. The system of claim 16, wherein the processor is configured to execute the machine-readable instructions to:
present the passive content via the passive pixels of the electrophoretic layer; and
cause the active pixels of the electrophoretic layer to be black.

19. The system of claim 14, wherein the transparent emissive layer comprises an organic light-emitting diode (OLED) layer.

20. The system of claim 14, wherein the electrophoretic layer comprises an E-Ink layer.
